(19) United States
(12) Patent Application Publication
(10) Pub. No.: US 2026/0018059 A1
(43) Pub. Date: Jan. 15, 2026

(54) LONGITUDINAL VELOCITY PLANNING FOR LANE CHANGE MANEUVERS

(71) Applicant: GM Global Technology Operations LLC, Detroit, MI (US)

(72) Inventors: Harsh Ketan Patel, New Hudson, MI (US); Paul A. Adam, Milford, MI (US); Tetyana V. Mamchuk, Novi, MI (US); Kevin A. O'Dea, Ann Arbor, MI (US)

(21) Appl. No.: 18/766,759

(22) Filed: Jul. 9, 2024

(51) Int. Cl. G08G 1/16; B60W 30/16; B60W 60/00

(52) U.S. Cl. CPC G08G 1/167; B60W 30/16; B60W 60/001; B60W 2720/10

(57) ABSTRACT

A system for controlling a vehicle includes a monitoring system configured to detect a lane change feature during operation of a vehicle, the lane change feature including at least one of a lane addition feature and a lane split feature. The system also includes a planning module configured to, based on detection of the lane change feature, acquire a trajectory for the vehicle to perform a lane change maneuver at the lane change feature within a time window, the time window selected based on a current velocity of the vehicle, and calculate a longitudinal velocity profile prescribing a sequence of longitudinal velocities selected so that when the vehicle follows the acquired trajectory, the lane change maneuver is performed in a smooth manner within the time window. The system also includes a control module configured to control movement of the vehicle according to the acquired trajectory.

### INTRODUCTION

The subject disclosure relates to the art of vehicle control. More particularly, the subject disclosure relates to systems and methods for controlling longitudinal acceleration of a vehicle.

Vehicles are increasingly equipped with sensors and perception devices that improve the awareness of vehicle control systems and drivers, and can thereby provide for autonomous control and/or driver support. For example, vehicles may feature autonomous and/or semi-autonomous drive modes, such as fully autonomous control and automated control of specific functions (e.g., parking assist, automated control during highway driving, brake assist, etc.). It is desirable to improve aspects of autonomous and automated control to improve a driver's experience.

### SUMMARY

In one exemplary embodiment, a system for controlling a vehicle includes a monitoring system configured to detect a lane change feature during operation of a vehicle, the lane change feature including at least one of a lane addition feature and a lane split feature. The system also includes a planning module configured to, based on detection of the lane change feature, acquire a trajectory for the vehicle to perform a lane change maneuver at the lane change feature within a time window, the time window selected based on a current velocity of the vehicle, and calculate a longitudinal velocity profile prescribing a sequence of longitudinal velocities selected so that when the vehicle follows the acquired trajectory, the lane change maneuver is performed in a smooth manner within the time window. The system also includes a control module configured to control movement of the vehicle according to the acquired trajectory and execute the lane change maneuver according to the sequence of longitudinal velocities.

In addition to one or more of the features described herein, the longitudinal velocity profile is calculated so that a lateral acceleration is within a selected threshold.

In addition to one or more of the features described herein, the lane change feature includes the lane addition feature at a first location and the lane split feature at a second location, and the longitudinal velocity profile is calculated based on a distance between the first location and the second location, and the current velocity.

In addition to one or more of the features described herein, the longitudinal velocity profile is calculated based on a plurality of constituent velocity profiles.

In addition to one or more of the features described herein, the plurality of constituent velocity profiles includes an insertion velocity profile and a curve velocity profile.

In addition to one or more of the features described herein, the plurality of constituent velocity profiles include a headway velocity selected to maintain a distance between the vehicle and another vehicle moving ahead of the vehicle.

In addition to one or more of the features described herein, the longitudinal velocity profile is calculated by blending the plurality of constituent velocity profiles.

In addition to one or more of the features described herein, each constituent velocity profile of the plurality of constituent velocity profiles is expressed as a third order polynomial.

In addition to one or more of the features described herein, the blending includes selecting a constituent velocity profile having a lowest velocity value, or combining the plurality of constituent velocity profiles using a matrix technique.

In another exemplary embodiment, a method of controlling a vehicle includes detecting a lane change feature during operation of a vehicle, the lane change feature including at least one of a lane addition feature and a lane split feature, and based on detection of the lane change feature, acquiring, by a planning module, a trajectory for the vehicle to perform a lane change maneuver at the lane change feature within a time window, the time window selected based on a current velocity of the vehicle. The method also includes calculating a longitudinal velocity profile prescribing a sequence of longitudinal velocities selected so that when the vehicle follows the acquired trajectory, the lane change maneuver is performed in a smooth manner within the time window, and controlling movement of the vehicle according to the acquired trajectory and executing the lane change maneuver according to the sequence of longitudinal velocities.

In addition to one or more of the features described herein, the longitudinal velocity profile is calculated so that a lateral acceleration is within a selected threshold.

In addition to one or more of the features described herein, the lane change feature includes the lane addition feature at a first location and the lane split feature at a second location, and the longitudinal velocity profile is calculated based on a distance between the first location and the second location, and the current velocity.

In addition to one or more of the features described herein, the longitudinal velocity profile is calculated based on a plurality of constituent velocity profiles, and the plurality of constituent velocity profiles includes an insertion velocity profile and a curve velocity profile.

In addition to one or more of the features described herein, the plurality of constituent velocity profiles include a headway velocity selected to maintain a distance between the vehicle and another vehicle moving ahead of the vehicle.

In addition to one or more of the features described herein, the longitudinal velocity profile is calculated by blending the plurality of constituent velocity profiles.

In addition to one or more of the features described herein, each constituent velocity profile is expressed as a third order polynomial, and the blending includes selecting a constituent velocity profile having a lowest velocity value, or combining the plurality of constituent velocity profiles using a matrix technique.

In yet another exemplary embodiment, a vehicle system includes a memory having computer readable instructions, and a processing device for executing the computer readable instructions, the computer readable instructions controlling the processing device to perform detecting a lane change feature during operation of a vehicle, the lane change feature including at least one of a lane addition feature and a lane split feature, based on detection of the lane change feature, acquiring, by a planning module, a trajectory for the vehicle to perform a lane change maneuver at the lane change feature within a time window, the time window selected based on a current velocity of the vehicle, calculating a longitudinal velocity profile prescribing a sequence of longitudinal velocities selected so that when the vehicle follows the acquired trajectory, the lane change maneuver is performed in a smooth manner within the time window, and controlling movement of the vehicle according to the acquired trajectory and executing the lane change maneuver according to the sequence of longitudinal velocities.

In addition to one or more of the features described herein, the lane change feature includes the lane addition feature at a first location and the lane split feature at a second location, and the longitudinal velocity profile is calculated based on a distance between the first location and the second location, and the current velocity.

In addition to one or more of the features described herein, the longitudinal velocity profile is calculated based on a plurality of constituent velocity profiles, wherein the plurality of constituent velocity profiles includes an insertion velocity profile and a curve velocity profile.

In addition to one or more of the features described herein, the longitudinal velocity profile is calculated by blending the plurality of constituent velocity profiles.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle, in accordance with an exemplary embodiment;

FIG. 2 is a flow diagram depicting aspects of a planning and control method, in accordance with an exemplary embodiment;

FIG. 3 depicts an example of a vehicle trajectory for performing a lane change maneuver at a lane change feature of a roadway;

FIG. 4 depicts an example of a lane change feature;

FIG. 5 is a flow diagram depicting aspects of calculating a longitudinal velocity profile (e.g., as part of the method of FIG. 2), in accordance with an exemplary embodiment;

FIG. 6A depicts examples of constituent velocity profiles, and aspects of blending the constituent velocity profiles to calculate a longitudinal velocity profile (e.g., as part of the method of FIG. 2), in accordance with an exemplary embodiment;

FIG. 6B depicts an example of a lane change feature;

FIG. 7 is a flow diagram depicting aspects of generating acceleration and/or deceleration commands based on a longitudinal velocity profile (e.g., as part of the method of FIG. 2), in accordance with an exemplary embodiment; and

FIG. 8 depicts a computer system in accordance with an exemplary embodiment;

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems are provided for planning and controlling operation of a vehicle for execution of a lane change. The lane change may be the result of a lane change feature at an upcoming location of a route, such as a road location where a lane transitions into multiple lanes or a highway exit lane is encountered. An embodiment of a planning and control system is configured to determine a vehicle trajectory for making a lane change, and formulate a velocity profile that provides a contiguous and smooth motion along the trajectory that is pleasing to vehicle users. The velocity profile may be formulated by blending a plurality of individual velocity profiles. Each individual velocity profile (referred to as a “constituent velocity profile”) may account for a different condition or factor.

Embodiments described herein present a number of advantages. For example, the embodiments provide for enhancing vehicle response to lane change features and improving a driver or passenger experience. For example, the embodiments provide for a smooth and pleasing driver experience. In addition, embodiments are able to provide such an experience, while providing for more complex velocity profiles than existing methods.

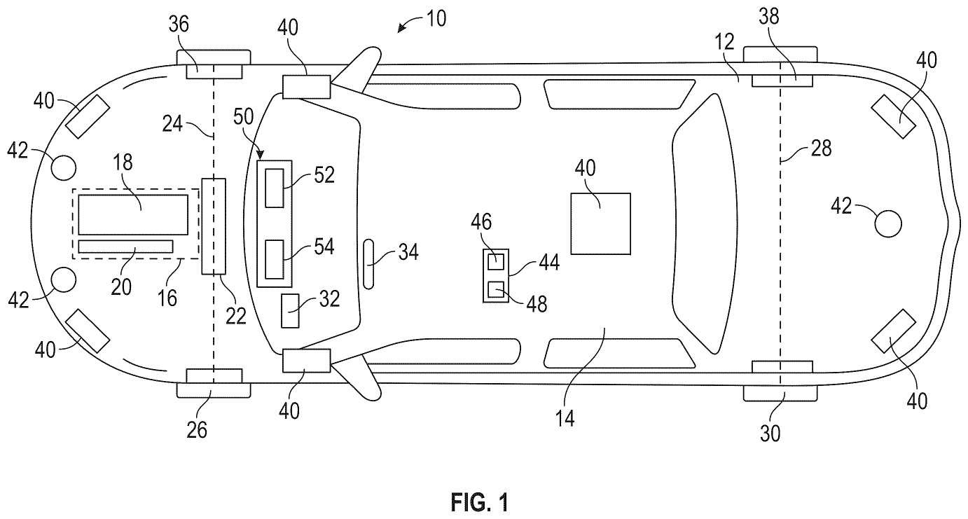

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion systems 16 and other vehicle components, such as a braking subsystem, a suspension system, a steering subsystem, and if the vehicle is a hybrid electric vehicle, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor 20. The vehicle 10 may be a fully electric vehicle having one or more electric motors.

The propulsion system 16 includes various other components, such as a transmission system 22 for applying torque to a front drive shaft 24 connected to front wheels 26. The propulsion system 16 is not so limited. For example, the propulsion system 16 may include components (e.g., transmission, the motor 20 and/or an additional motor) for driving a drive shaft 28 connected to rear wheels 30.

The vehicle 10 also includes various control devices for controlling aspects of vehicle operation. Such devices include, for example, an accelerator 32, steering wheel 34, front brakes 36 and rear brakes 38.

The vehicle also includes a monitoring system and a vehicle control system, aspects of which may be incorporated in or connected to the vehicle 10. The monitoring system in this embodiment includes one or more optical cameras 40 configured to take images, which may be still images and/or video images. Additional devices or sensors may be included, such as one or more radar assemblies 42 included in the vehicle 10. The monitoring system is not so limited and may include other types of sensors, such as lidar and infrared.

Control devices and actuators, and other components such as the monitoring system, are controllable via one or more control units, collectively represented by a vehicle controller 44. The vehicle controller 44 includes processing components for controlling aspects of vehicle operation, such as control of propulsion, braking and steering, as well as functions such as monitoring and path planning.

The vehicle controller 44 may be configured to control the vehicle 10 in accordance with various forms of automated control. In an embodiment, the vehicle controller 44 is configured for one or more automation levels, such as Level 1, Level 2 and/or Level 3 automation. Level 1 automation includes driver assistance. Level 2 automation allows for vehicle control of steering and acceleration, with the driver monitoring and ready to take control at any time. In Level 3 automation (conditional automation), a vehicle can monitor the environment and automatically control the operation.

For example, the vehicle controller 44 includes a planning module 46 configured to calculate trajectories or otherwise plan vehicle control based on factors such as a planned route and features of the route and environment around the vehicle. In an embodiment, the planning module 46 is configured to determine a path for the vehicle 10 when the vehicle 10 is being operated autonomously or semi-autonomously (e.g., lane assist, Supercruise®, etc.). A control module 48 receives planning information and controls vehicle movement based thereon.

The vehicle 10, monitoring system, the vehicle controller 44 and other vehicle systems are included in, or are connected to, an on-board computer system 50 that includes one or more processing devices 52 and a user interface 54. The user interface 54 may include a touchscreen, a speech recognition system and/or various buttons for allowing a user to interact with features of the vehicle. The user interface 54 may be configured to interact with a user or driver via visual communications (e.g., text and/or graphical displays), tactile communications or alerts (e.g., vibration), and/or audible communications.

In an embodiment, the vehicle controller 44 (or other suitable processing device or system) is configured to determine a path or spatial trajectory for the vehicle 10 to travel when approaching a lane change feature, in order to transition the vehicle 10 to a desired lane. A “lane change feature” refers to a feature of a roadway, or a situation or condition, that may prompt the vehicle 10 to perform a lane change in order to follow a desired route. In an embodiment, a lane change feature includes a lane addition feature in which a lane is added in the vehicle's route, and/or a lane split feature in which a lane splits into two or more lanes.

The trajectory may be determined by the vehicle controller 44, or received from another system, such as the vehicle's autonomous control or driving assist system. The trajectory, and current conditions such as the current vehicle velocity and distances associated with the lane change feature, are then used to calculate a longitudinal velocity profile that prescribes a velocity or velocity pattern that causes the vehicle to perform a lane change in a smooth manner. A “smooth” manner refers to a manner in which the longitudinal and lateral movements are performed to follow a contiguous path and changes in velocity are gradual or otherwise are not abrupt or unpleasant for vehicle users (e.g., the changes in velocity avoid any excessive or undesirable lateral and longitudinal accelerations, avoid any abrupt changes in velocity and direction, etc.).

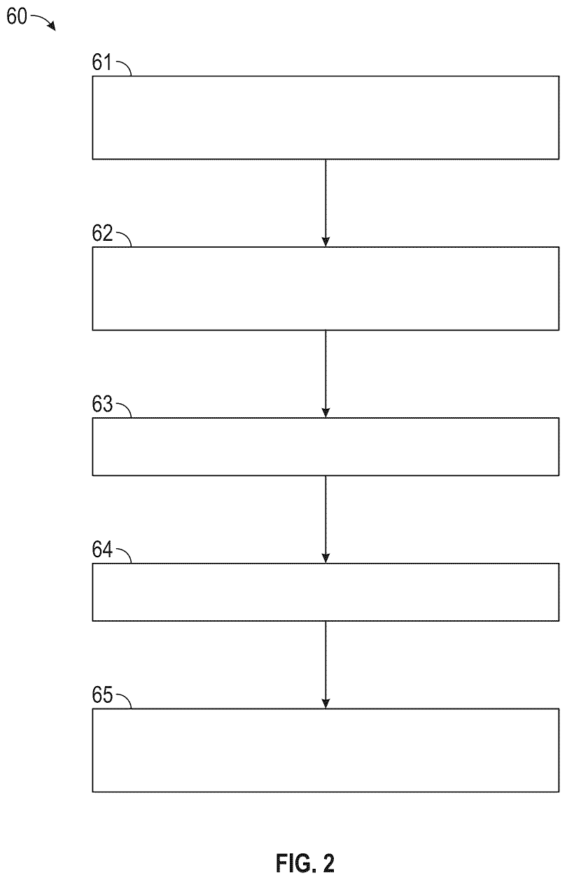

FIG. 2 depicts an embodiment of a method 60 of planning and executing a lane split maneuver. A “lane split maneuver” is a set of actions performed by a driver or control system to approach a lane change feature and move laterally and longitudinally to enter a lane at or near the lane change feature.

The method 60 is discussed in conjunction with blocks 61-65. The method 60 is not limited to the number or order of steps therein, as some steps represented by blocks 61-65 may be performed in a different order than that described below, or fewer than all of the steps may be performed. The method 60 is discussed in conjunction with the vehicle of FIG. 1 and a processing system, which may be, for example, the computer system 50, the vehicle controller 44, or a combination thereof.

The methods discussed herein are described as being performed by the vehicle controller 44. It is noted that the methods are not so limited and may be performed by any suitable processing device or system, or combination of processing devices.

At block 61, during vehicle operation, the monitoring system detects that a lane change feature is upcoming (e.g., via image data), or a vehicle system otherwise detects the lane change feature (e.g., from route and map information). Examples of a lane change feature include a highway exit, splitting of lanes due to a work zone, addition of a lane (e.g., the number of lanes increases or decreases, a slow vehicle lane, etc.). Lane splitting can also occur due to freeways (or other roadways) bisecting into multiple freeways.

The controller 44 determines whether the lane change feature necessitates a lane change maneuver. The maneuver may be necessitated by local conditions (e.g., the vehicle 10 must move to one lane, such as a lane split in a work zone), or by a planned route (e.g., the vehicle must enter an exit lane to follow a planned route).

At block 62, if the controller 44 determines that a lane change maneuver is to be performed, the controller 44 determines a path or spatial trajectory that the vehicle 10 is to follow to execute the maneuver. The trajectory may be determined in any suitable manner. In an embodiment, an open loop trajectory calculation is performed.

An open loop method can be used to calculate a trajectory for curve speed or velocity. For example, if the vehicle 10 is operating on a high curvature road, a speed reduction (if needed) is requested in open loop manner to comfortably traverse through high curvature roads. Another trajectory can be calculated to allow a driver to create a courtesy request in order to allow a target vehicle to merge in front of the vehicle 10. The speed profile itself is generated in open loop fashion (i.e., without feedback).

At block 63, the controller 44 estimates or acquires lateral acceleration and deceleration limits.

At block 64, the controller 44 calculates a longitudinal velocity profile that the vehicle 10 is to adhere to as the vehicle 10 follows the determined trajectory. The longitudinal velocity profile (or simply “velocity profile”) prescribes a longitudinal velocity or a series of longitudinal velocities at various locations along the determined path. The longitudinal profile may thus prescribe, in conjunction with the trajectory, a series of vehicle behaviors (e.g., steering, accelerating and/or braking).

In an embodiment, the velocity profile is calculated by blending a plurality of constituent velocity profiles. The constituent velocity profiles, in an embodiment, include an insertion velocity profile and/or a curve velocity profile. If a leading vehicle is traveling ahead of the vehicle 10, the constituent velocity profiles include a headway velocity profile selected so that the vehicle 10 maintains a desired distance from the leading vehicle.

At block 65, the controller 44 executes the lane change maneuver according to the determined trajectory and the longitudinal velocity profile. For example, the controller 44 provides actuator commands (i.e., propulsion and braking) as needed to maintain the vehicle velocity within some range of a desired velocity.

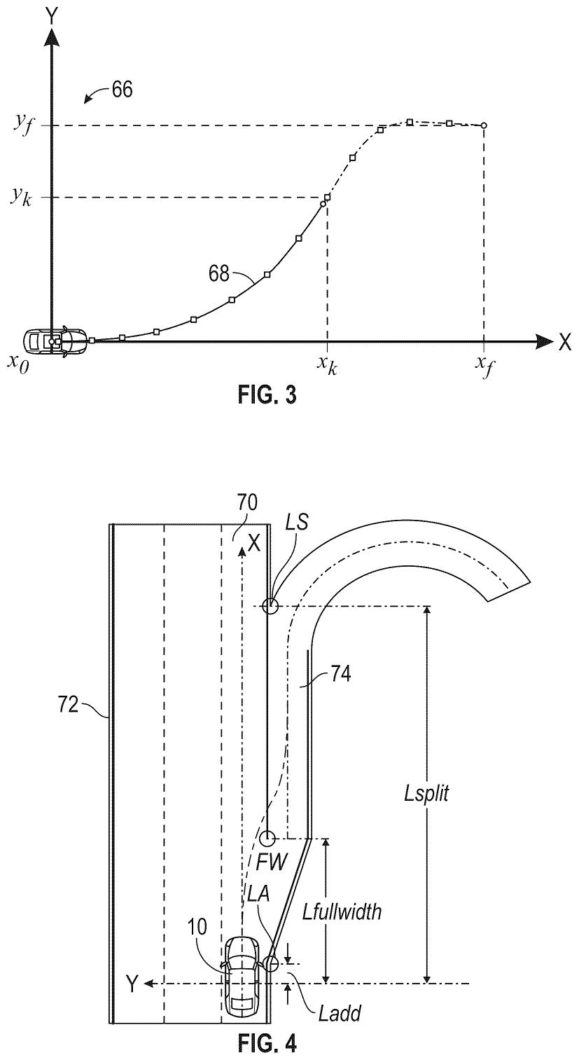

FIG. 3 depicts an example of a trajectory used by the controller 44 to control the vehicle 10 to make a lane change from a current lane to a target lane. The trajectory, when combined with a longitudinal velocity profile as described herein, prescribes a sequence of behaviors (steering, acceleration and/or deceleration) that cause the vehicle 10 to follow the trajectory in a smooth and pleasing manner.

The trajectory is represented in a graph 66 of lateral distance y(x) travelled as a function of longitudinal distance x(t), where t is time. The origin (x₀,y₀) is a current vehicle location. The vehicle trajectory is shown as a curve 68. It is noted that the controller 44 may calculate the curve 68 during performance of the method 60, or the curve 68 may be a pre-planned or stored path accessible by the controller 44.

The trajectory in this example is modeled as a third order polynomial function, although embodiments are not so limited, as other polynomial functions or any other suitable functions may be used. Polynomials having other orders may be used (e.g., fourth order, fifth order, etc.).

As shown, the curve 68 is divided into a series of segments xₖ defined by waypoints k. The total distance x_{f} is a function of the distance from the origin and the vehicle velocity Vₕₒₛₜ. The trajectory (e.g., the curve 68) can be represented by:

$$y ( x ) = {a}_{0} + {a}_{1} x + {a}_{2} {x}^{2} + {a}_{3} {x}^{3} . \qquad ( 1 )$$

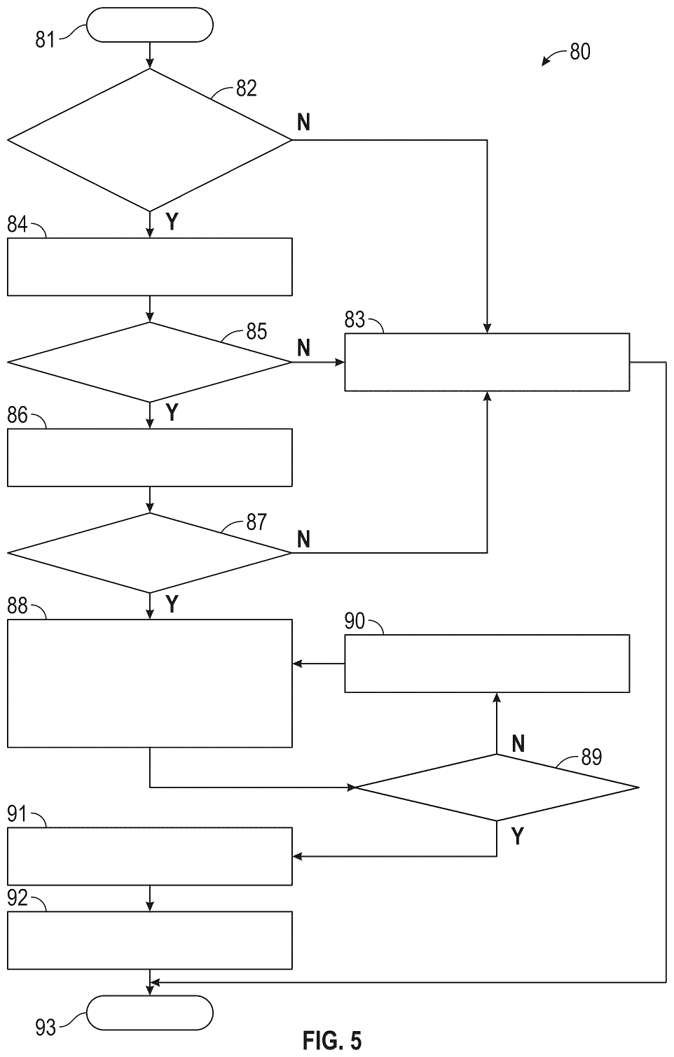

This equation is solved for each segment by solving for coefficients a₀, a₁, a₂ and a₃ given y-values denoted as y, y′ and y″, where y is a value at a beginning of the segment, y′ is an intermediate value, and y″ is a value at an end of the segment. Equation (1) is subject to the constraint that the total distance x_{f} is greater than a distance available to make the lane change (e.g., x_{f}>L_{fullwidth} and <Lₛₚₗᵢₜ, as discussed further herein in conjunction with FIG. 4).

Various distances that may be accounted for in performing the method 60 are shown in FIG. 4. It is noted that embodiments are not limited to the distances discussed with reference to FIG. 4.

FIG. 4 depicts an example of a lane change feature, and parameters used to determine a vehicle path and longitudinal velocity profile. In this example, the vehicle 10 is traveling in a lane 70 of a highway 72, and the lane change feature is in the form of an exit lane 74 of an interchange. Various distances are defined from a location of the vehicle 10 (“host location”) and various other locations at or near the exit lane 74. L_{add} is defined as a distance from the host location to a location LA (“lane add location”) where the exit lane 74 is added, and L_{fullwidth} is a distance from the host location to a location FW where the exit lane 74 reaches its full width. Lₛₚₗᵢₜ is a distance from the host location to a location LS (“lane split location”) at which the exit lane 74 splits from, or diverges from the highway 72, and has a curvature. These distances are in a longitudinal direction, which is parallel to an instantaneous direction in which the vehicle 10 is traveling.

The lane split location LS can also be defined as a point of no return. In other words, if the vehicle 10 passes the lane split location without a successful insertion into a new (e.g., split or added) lane, such as the exit lane 74, the vehicle 10 cannot successfully enter the new lane beyond this location. Furthermore, if a lane change into the new lane is made prior to reaching the lane split location LS, the vehicle 10 cannot successfully return to the original lane (e.g., the lane 70) once the vehicle passes the lane split location. Beyond that location, re-routing will be the only viable option for the vehicle 10 if the vehicle is to reach a planned destination.

The longitudinal velocity profile is calculated based on the trajectory. The velocity profile is determined based on parameters of the trajectory, such as curvature, initial vehicle velocity, as well as various distances and features of the roadway and lane split. In addition, the velocity profile is subject to limits in order to stay within lateral acceleration constraints, in order to ensure a smooth lane change.

A curvature k(x) for each segment is defined as:

$$k ( x ) = \frac{\vert {y ( x )}^{″} \vert}{\sqrt{{( 1 + {y ( x )}^{′2} )}^{3}}} . \qquad ( 2 )$$

For each segment of a trajectory, a desired velocity V_{Des} is calculated. The desired velocity V_{Des} is determined as a function of a crossing window length, defined as a distance available for the vehicle 10 to make the lane change. The desired velocity V_{Des} is also a function of an allowable time window or maximum time for the vehicle 10 to make the lane change. The desired velocity can thus be expressed as V_{Des}=f(window length, maximum time).

The desired velocity V_{Des} is calculated such that limits of lateral acceleration a_{y} are not exceeded. A limit for a given segment may be defined as Kₜₕᵣₑₛₕ*a_{y}, where Kₜₕᵣₑₛₕ is a coefficient selected to define a maximum allowable lateral acceleration. The limit is used to determine a maximum velocity. Accordingly, the desired velocity is minimum of f(window length, maximum time) and the maximum velocity. The desired velocity V_{Des} in each segment is also determined so that the lane change maneuver is completed within a time window and distance constraints.

For example, the desired velocity V_{Des} is a function of L_{CW} and “time to Lₛₚₗᵢₜ”. L_{CW} represents the available distance (e.g., L_{CW}=Lₛₚₗᵢₜ−L_{add}). “Time to Lₛₚₗᵢₜ” is an amount of time for the vehicle 10 to traverse from a current position to the location LS at which the exit lane splits or curves (traverse the distance Lₛₚₗᵢₜ). The desired velocity V_{Des} in this example is:

$${V}_{des} = min ( \sqrt{\frac{{K}_{thresh} {a}_{y}}{Maximum curvature}} , f ( {L}_{CW} , time to {L}_{split} ) . \qquad ( 3 )$$

A deceleration rate A_{decel} is calculated as:

$${A}_{decel} = \sqrt{\frac{( {V}_{host}^{2} ) - ( {V}_{Des}^{2} )}{2 {L}_{add}}} , \qquad ( 4 )$$

where Vₕₒₛₜ is the current velocity of the vehicle (i.e., the velocity at the beginning of a segment).

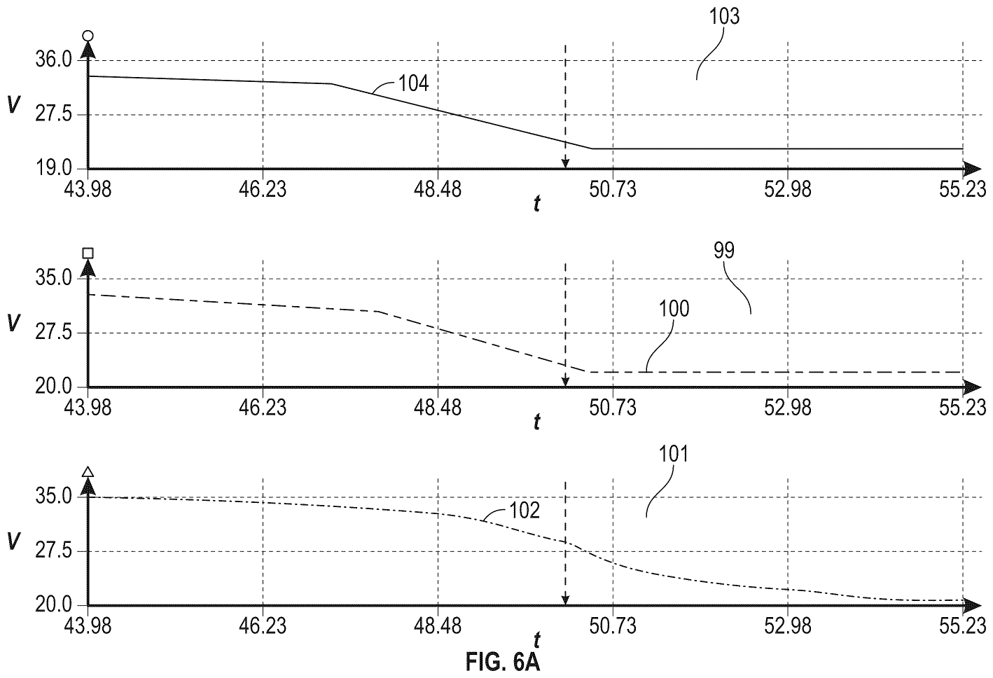

FIG. 5 depicts an embodiment of a method 80 of planning and executing a lane change maneuver. The method 80 is discussed in conjunction with blocks 81-93. The method 80 is not limited to the number or order of steps therein, as some steps represented by blocks 81-93 may be performed in a different order than that described below, or fewer than all of the steps may be performed.

In an embodiment, the method 80 includes a closed loop calculation of a longitudinal velocity profile. The calculation continuously or periodically receives feedback from the vehicle 10 and/or sensors.

The method 80 is discussed with the exit ramp 74 for illustration purposes. However, the method 80 is applicable to any form of lane change feature or any suitable condition or situation where a lane change is necessitated or desired.

At block 81, planning for a lane change maneuver starts when the vehicle 10 is within some distance from a lane split. For example, planning starts when the vehicle 10 detects an oncoming lane change feature, such as the exit ramp 74, via the monitoring system (e.g., visual detection using camera and/or radar imaging), or when the controller 44 otherwise detects that the vehicle is approaching the lane change feature (e.g., via map and GPS data).

At block 82, the controller determines whether the vehicle 10 is in an operating mode conducive to automated control. Operating modes that are conducive include, for example, fully autonomous operation and other levels of automated control such as level 2 type autonomous control.

At block 83, if the vehicle 10 is not in a suitable operating mode, no velocity request is generated and the desired velocity V_{Des} is equal to the current velocity Vₕₒₛₜ.

At block 84, the controller 44 determines the distance available for the vehicle 10 to execute a lane change to enter the exit lane 74. For example, the controller 44 determines the lane add location LA and the lane split location LS (e.g., from a route tree, map or other suitable information), and calculates Lₛₚₗᵢₜ and L_{add}. The distance available, L_{CW}, is calculated by subtracting L_{add} from Lₛₚₗᵢₜ.

At block 85, the controller 44 compares the distance available to a threshold distance, and determines whether the available distance is greater than a threshold or minimum distance. For example, the controller 44 determines whether L_{CW} is greater than a minimum distance K_{CWthresh}. If not, the method 80 proceeds to block 83.

At block 86, if the available distance is greater than the minimum, the controller 44 calculates a deceleration rate A_{decel}. The deceleration rate is an amount of deceleration needed to slow the vehicle 10 to the desired velocity V_{Des}, and is based on the vehicle's current velocity Vₕₒₛₜ and distance L_{decel} permitted to initiate a deceleration request. A_{decel} may be calculated as:

$${A}_{decel} = \frac{( {V}_{host}^{2} ) - ( {V}_{Des}^{2} )}{2 {L}_{add}} , \qquad ( 5 )$$

At block 87, the controller 44 compares the deceleration rate to a threshold or maximum deceleration K_{decelmin}, and determines whether the deceleration rate is less than the maximum deceleration. If not, the method 80 proceeds to block 83.

At block 88, if the deceleration rate is less than the maximum, the controller 44 determines the time remaining until a deceleration request is initiated. The time remaining (denoted as T_{decel}) may be calculated by multiplying the vehicle velocity Vₕₒₛₜ by L_{decel}.

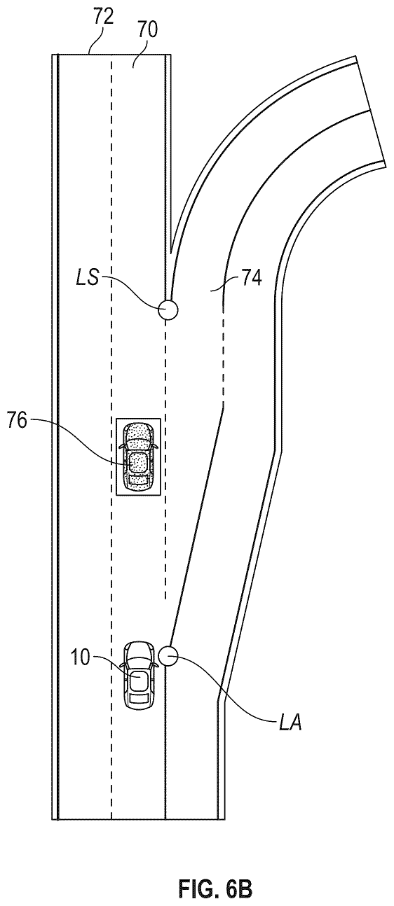

Calculation of T_{decel} is not limited to multiplying Vₕₒₛₜ by L_{decel}. In an embodiment, the controller 44 accounts for a desired velocity profile when determining the time remaining, by calculating an amount of time that the vehicle 10 should wait to initiate deceleration, so that a consistent and smooth deceleration profile is achieved. For example, a pre-determined velocity profile (e.g., a profile similar to profile 100 of FIG. 6) is used and T_{decel} is calculated so that deceleration is initiated at a time that allows for deceleration according to the profile.

At block 89, T_{decel} is monitored, and it is continuously or periodically determined whether T_{decel} has reached zero. If T_{decel} is not yet zero, the controller 44 waits (block 90), re-calculates T_{decel} (block 88) and proceeds again to block 89.

At block 91, upon determining that T_{decel} is zero, the controller 44 initiates deceleration by sending a velocity request to longitudinal controls (e.g., brake and/or accelerator controls), and determines acceleration commands to cause the vehicle 10 to adhere to the velocity profile (block 92). The method 80 ends at block 93.

In an embodiment, the longitudinal velocity profile is calculated by combining or blending a plurality of constituent velocity profiles. Each constituent velocity profile can account for a different feature or condition (or set of features or conditions). For example, individual velocity profiles can be calculated for the trajectory to account for curve velocity, headway control, route velocity, courtesy velocity, and others. By defining different and independent velocity profiles, more complex velocity profiles can be derived and account for more complex situations than existing planning methods.

FIG. 6A depicts examples of constituent velocity profiles for making a lane change at an exit. FIG. 6A shows a set of graphs 99, 101 and 103 of velocity V as a function of time t. FIG. 6B shows the highway 72 and exit lane 74, in which the vehicle 10 is approaching the lane 74. In this example, another vehicle 76 is traveling ahead of the vehicle 10.

The graph 99 includes a curve velocity or curve speed profile 104 for entering a road segment having a high curvature. The curve velocity profile indicates a velocity pattern that causes the vehicle 10 to reach a target velocity within the time window (i.e., desired velocity at x_{f} of the trajectory), where the target velocity is based on a curvature after the lane split location LS (FIG. 6B). The target velocity is determined in any suitable manner, such as by accessing map or route information having suggested velocities.

An insertion velocity profile 100 is a profile that maintains the vehicle 10 at longitudinal velocities so that lateral acceleration is within desired limits as the vehicle enters the lane 74. This profile is determined such that the desired velocity is low enough so that the vehicle can smoothly enter the target lane 74.

A headway velocity profile 102 is a velocity profile that causes the vehicle 10 to maintain a desired spacing or distance between the vehicle 10 and the other vehicle 76 (or any other target object in front of the vehicle 10) while making the lane change.

Each of the above profiles may be calculated as discussed herein, according to the planned trajectory. The profiles are then combined or blended to calculate a final velocity profile that provides for simultaneous management of speed or velocity for maintaining headway with preceding target, speed for ramp insertion window, and speed for upcoming curve in the ramp. It is noted that embodiments are not limited to these examples, as fewer than the above may be blended (e.g. if there are no headway vehicles or obstacles), or more than three may be blended (e.g., additional profiles may be generated for other features and conditions).

The profiles may be blended or combined in different ways. For example, the final profile velocity may be determined by selecting the constituent profile having the slowest maximum velocity (or other attribute such as average velocity or target velocity).

In an embodiment, each of the profiles are expressed as a third order polynomial, where v₁ is a velocity profile for the curve velocity profile, v₂ is a velocity profile for the insertion velocity profile, and v₃ is a velocity profile for the headway velocity profile:

$$\begin{matrix}{v}_{1} = {a}_{0} + {a}_{1} {x}_{1} + {a}_{2} {x}_{1}^{2} + {a}_{3} {x}_{1}^{3} \\ {v}_{2} = {b}_{0} + {b}_{1} {x}_{2} + {b}_{2} {x}_{2}^{2} + {b}_{3} {x}_{2}^{3} \\ {v}_{3} = {c}_{0} + {c}_{1} {x}_{3} + {c}_{2} {x}_{3}^{2} + {c}_{3} {x}_{3}^{3}\end{matrix} . \qquad ( 6 )$$

The profiles, in an embodiment, are converted to a matrix system and an augmented matrix as follows:

$$[ \begin{matrix}{v}_{1} \\ {v}_{2} \\ {v}_{3}\end{matrix} ] = [ \begin{matrix}{a}_{0} & {a}_{1} & {a}_{2} & {a}_{3} \\ {b}_{0} & {b}_{1} & {b}_{2} & {b}_{3} \\ {c}_{0} & {c}_{1} & {c}_{2} & {c}_{3}\end{matrix} ] [ \begin{matrix}1 \\ {x}_{1} \\ {x}_{2} \\ {x}_{3}\end{matrix} ] \qquad ( 7 )$$

$$[ \begin{matrix}{v}_{1} : & {a}_{0} & {a}_{1} & {a}_{2} & {a}_{3} \\ {v}_{2} : & {b}_{0} & {b}_{1} & {b}_{2} & {b}_{3} \\ {v}_{3} : & {c}_{0} & {c}_{1} & {c}_{2} & {c}_{3}\end{matrix} ] .$$

The above system may be solved by employing Gaussian elimination on a sequence of augmented matrices until a final matrix is a triangular matrix in the upper triangular form. In this way, individual profiles, which account for different requirements, are blended into a final longitudinal control request.

Embodiments are not limited to the specific blending methods, as any suitable method or technique may be used to combine the constituent profiles. For example, blending may be performed using machine learning techniques.

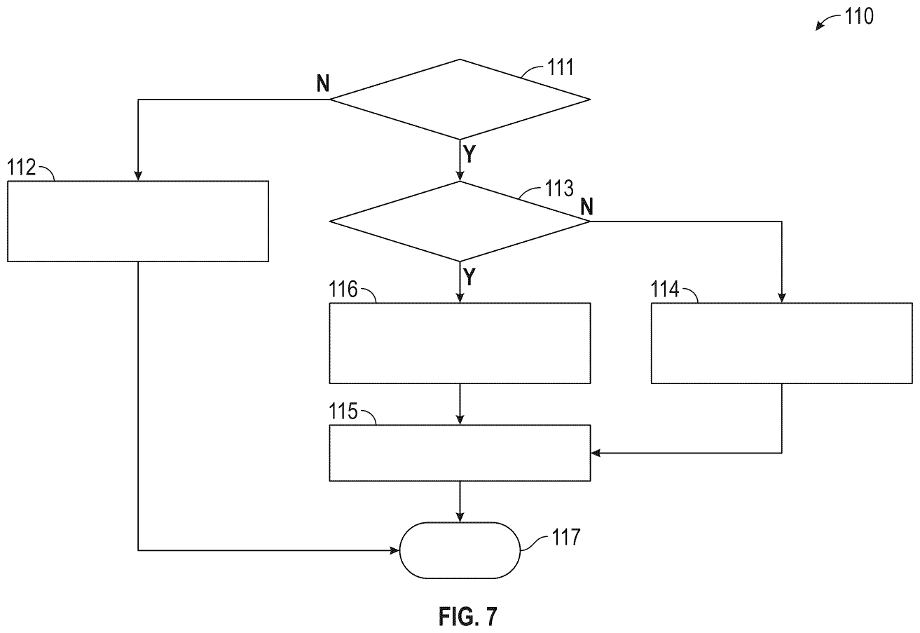

FIG. 7 depicts an embodiment of a method 110 of determining vehicle controls for making a lane change at a lane change feature, such as the exit lane 74. The method 110 utilizes a planned trajectory and a longitudinal velocity profile generated as described herein, and is initiated based on the vehicle 10 detecting an upcoming lane change feature and successfully generating the trajectory and velocity profile.

The method 110 is discussed in conjunction with blocks 111-117. The method 110 is not limited to the number or order of steps therein, as some steps represented by blocks 111-117 may be performed in a different order than that described below, or fewer than all of the steps may be performed.

The method 110, in an embodiment, is a closed loop control methodology that utilizes open loop calculation of the planned trajectory, in combination with closed loop control of longitudinal velocity (i.e., acceleration and deceleration). The method 110 may be repeatedly performed for each of a plurality of successive segments of a trajectory (e.g., segments of FIG. 3).

At block 111, the controller 44 receives a trajectory and a velocity profile, and determines whether the vehicle 10 is in a suitable operating mode that supports automated control for a lane change. If the vehicle 10 is not in a suitable operating mode, a lane change is not performed and other non-route related functions are performed (block 112).

At block 113, if the vehicle 10 is in a suitable operating mode, the planning module 46 acquires a target velocity from the longitudinal velocity profile, and also determines the current location and velocity of the vehicle 10. A velocity error is calculated to determine whether the vehicle 10 is travelling at or near the desired velocity at the current location, and thereby determine whether a deceleration command (i.e. brake command A_{Brk}) is needed.

The velocity error (denoted as Vₑᵣᵣₒᵣ) is calculated as a difference between the current velocity Vₕₒₛₜ and the target velocity V_{Des}. The error Vₑᵣᵣₒᵣ is compared to an error threshold V_{ErrorRoute}, which may be a minimum difference between Vₕₒₛₜ and V_{des}.

At block 114, if the error is less than or equal to V_{ErrorRoute}, deceleration is not needed (A_{Brk}=0). An acceleration command (A_{command}) may be provided as needed to maintain the vehicle at or near the desired velocity. For example, the acceleration command is a command Aₚᵣₒₚ provided (e.g., by the control module 48) to the accelerator 32 or other propulsion actuator. A_{command} may be rate limited at block 115 (e.g., to ensure that longitudinal and lateral acceleration is not excessive).

At block 116, if the error is greater than the minimum difference (Vₑᵣᵣₒᵣ>V_{ErrorRoute}), and the current velocity is less than the desired velocity, a braking command A_{Brk} is generated as a function of Vₑᵣᵣₒᵣ. If the current velocity is less than the desired velocity, an acceleration command (A_{command}=Aₚᵣₒₚ) is generated, rate limited (block 115) and provided to the propulsion actuator. The method ends at block 117, and may be repeated.

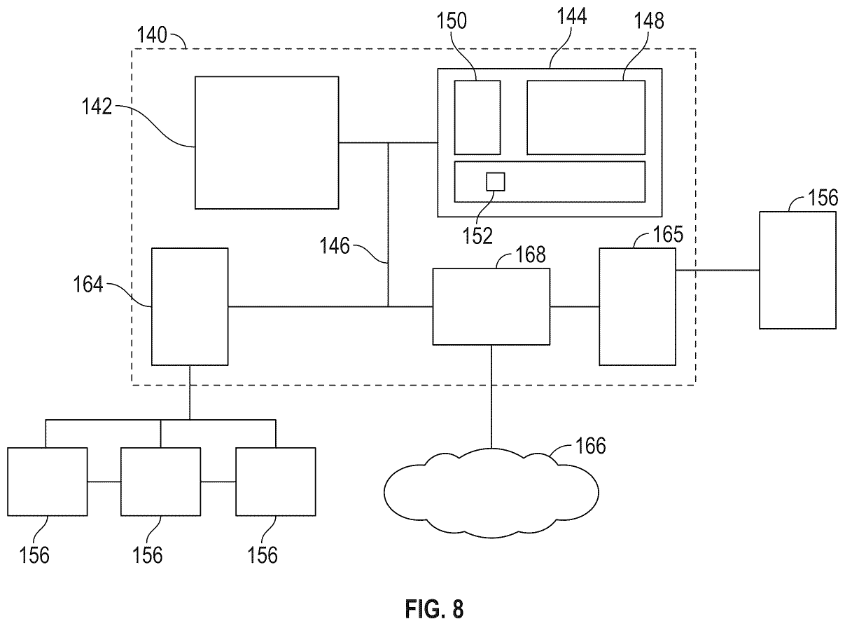

FIG. 8 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for controlling a vehicle, comprising:
a monitoring system configured to detect a lane change feature during operation of a vehicle, the lane change feature including at least one of a lane addition feature and a lane split feature;
a planning module configured to, based on detection of the lane change feature:
acquire a trajectory for the vehicle to perform a lane change maneuver at the lane change feature within a time window, the time window selected based on a current velocity of the vehicle; and
calculate a longitudinal velocity profile prescribing a sequence of longitudinal velocities selected so that when the vehicle follows the acquired trajectory, the lane change maneuver is performed in a smooth manner within the time window; and
a control module configured to control movement of the vehicle according to the acquired trajectory and execute the lane change maneuver according to the sequence of longitudinal velocities.

2. The system of claim 1, wherein the longitudinal velocity profile is calculated so that a lateral acceleration is within a selected threshold.

3. The system of claim 2, wherein the lane change feature includes the lane addition feature at a first location and the lane split feature at a second location, and the longitudinal velocity profile is calculated based on a distance between the first location and the second location, and the current velocity.

4. The system of claim 1, wherein the longitudinal velocity profile is calculated based on a plurality of constituent velocity profiles.

5. The system of claim 4, wherein the plurality of constituent velocity profiles includes an insertion velocity profile and a curve velocity profile.

6. The system of claim 5, wherein the plurality of constituent velocity profiles include a headway velocity selected to maintain a distance between the vehicle and another vehicle moving ahead of the vehicle.

7. The system of claim 4, wherein the longitudinal velocity profile is calculated by blending the plurality of constituent velocity profiles.

8. The system of claim 7, wherein each constituent velocity profile of the plurality of constituent velocity profiles is expressed as a third order polynomial.

9. The system of claim 8, wherein the blending includes selecting a constituent velocity profile having a lowest velocity value, or combining the plurality of constituent velocity profiles using a matrix technique.

10. A method of controlling a vehicle, comprising:
detecting a lane change feature during operation of a vehicle, the lane change feature including at least one of a lane addition feature and a lane split feature;
based on detection of the lane change feature, acquiring, by a planning module, a trajectory for the vehicle to perform a lane change maneuver at the lane change feature within a time window, the time window selected based on a current velocity of the vehicle;
calculating a longitudinal velocity profile prescribing a sequence of longitudinal velocities selected so that when the vehicle follows the acquired trajectory, the lane change maneuver is performed in a smooth manner within the time window; and
controlling movement of the vehicle according to the acquired trajectory and executing the lane change maneuver according to the sequence of longitudinal velocities.

11. The method of claim 10, wherein the longitudinal velocity profile is calculated so that a lateral acceleration is within a selected threshold.

12. The method of claim 11, wherein the lane change feature includes the lane addition feature at a first location and the lane split feature at a second location, and the longitudinal velocity profile is calculated based on a distance between the first location and the second location, and the current velocity.

13. The method of claim 10, wherein the longitudinal velocity profile is calculated based on a plurality of constituent velocity profiles, and the plurality of constituent velocity profiles includes an insertion velocity profile and a curve velocity profile.

14. The method of claim 13, wherein the plurality of constituent velocity profiles include a headway velocity selected to maintain a distance between the vehicle and another vehicle moving ahead of the vehicle.

15. The method of claim 13, wherein the longitudinal velocity profile is calculated by blending the plurality of constituent velocity profiles.

16. The method of claim 15, wherein each constituent velocity profile is expressed as a third order polynomial, and the blending includes selecting a constituent velocity profile having a lowest velocity value, or combining the plurality of constituent velocity profiles using a matrix technique.

17. A vehicle system comprising:
a memory having computer readable instructions; and
a processing device for executing the computer readable instructions, the computer readable instructions controlling the processing device to perform:
detecting a lane change feature during operation of a vehicle, the lane change feature including at least one of a lane addition feature and a lane split feature;
based on detection of the lane change feature, acquiring, by a planning module, a trajectory for the vehicle to perform a lane change maneuver at the lane change feature within a time window, the time window selected based on a current velocity of the vehicle;
calculating a longitudinal velocity profile prescribing a sequence of longitudinal velocities selected so that when the vehicle follows the acquired trajectory, the lane change maneuver is performed in a smooth manner within the time window; and
controlling movement of the vehicle according to the acquired trajectory and executing the lane change maneuver according to the sequence of longitudinal velocities.

18. The vehicle system of claim 17, wherein the lane change feature includes the lane addition feature at a first location and the lane split feature at a second location, and the longitudinal velocity profile is calculated based on a distance between the first location and the second location, and the current velocity.

19. The vehicle system of claim 17, wherein the longitudinal velocity profile is calculated based on a plurality of constituent velocity profiles, wherein the plurality of constituent velocity profiles includes an insertion velocity profile and a curve velocity profile.

20. The vehicle system of claim 19, wherein the longitudinal velocity profile is calculated by blending the plurality of constituent velocity profiles.
